(19) United States
(12) Patent Application Publication
(10) Pub. No.: US 2008/0036974 A1
(43) Pub. Date: Feb. 14, 2008

(54) DISPLAY DEVICE USING DIFFRACTIVE OPTICAL MODULATOR AND HAVING IMAGE DISTORTION FUNCTION

(75) Inventors: Shyshkin Ihar, Suwon (KR); Kwan Young Oh, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/837,386

(22) Filed: Aug. 10, 2007

(30) Foreign Application Priority Data
Aug. 10, 2006 (KR) 1020060075744

(51) Int. Cl. G03B 21/14

(52) U.S. Cl. 353/38

(57) ABSTRACT

Disclosed herein is a display device using a diffractive optical modulator and having a distortion correction function. The display device includes a light source unit, a condensing unit, an illumination unit, a diffractive optical modulator, a projection unit, a filter unit, and a distortion correction means. The light source unit includes a plurality of light sources for emitting beams of light. The condensing unit causes the beams of light to have an identical light path. The illumination unit converts the beams of light into linear light. The diffractive optical modulator modulates the linear light, so that diffracted light having a plurality of diffraction orders is generated. The projection unit produces an image by projecting the diffracted light onto a screen. The filter unit passes only diffracted light having at least one desired diffraction order therethrough. The distortion correction means includes a lens array for correcting an image.

### CROSS REFERENCE TO RELATED APPLICATION

This application claims the benefit of Korean Patent Application No. 10-2006-0075744, filed on Aug. 10, 2006, entitled “Display System Using One Panel Optical Modulator Having Distortion Reduction,” which is hereby incorporated by reference in its entirety into this application.

### BACKGROUND OF THE INVENTION

1. Field of the Invention

The present invention relates generally to a display device using a diffractive optical modulator, and, more particularly, to a display device using a diffractive optical modulator and having an image distortion function, which is provided with a distortion correction means, thus being able to correcting image distortion.

2. Description of the Related Art

With the development of micro technology, Micro-Electro-Mechanical System (MEMS) devices and small-sized apparatuses in which MEMS devices are included are attracting attention.

An MEMS device is configured in the form of a microstructure on a substrate, such as a silicon substrate or a glass substrate, and is formed by electrically and mechanically combining an actuation unit for outputting a mechanical actuating force with a semiconductor integrated circuit for controlling the actuation unit.

Recently, spatial light modulators using such MEMS devices have been developed. An example of such spatial light modulators is a Grating Light Value (GLV) disclosed in U.S. Pat. No. 5,311,360, which was granted to Bloom et al., another example thereof is a light intensity conversion device for a laser display developed by Silicon Light Machine (SLM) Co., and still another example thereof is a diffractive light modulator developed by Samsung Electro-Mechanics Co. Display devices using such spatial light modulators are well known, and a display device using a diffractive optical modulator is shown in FIG. 1 as an example thereof.

FIG. 1 is a diagram showing the construction of a prior art display device using a diffractive light modulator.

Referring to FIG. 1, the prior art display device using a diffractive optical modulator includes a light source unit 10, a condensing unit 12, an illumination unit 14, a diffractive optical modulator 18, a Fourier filter unit 20, a projection unit 24, and a screen 28.

Here, the light source unit 10 includes a plurality of light sources 11a˜11c. In an application thereof, the plurality of light sources 11a˜11c may be configured such that they are sequentially turned on. The condensing unit 12 includes a mirror 13a and a plurality of dichroic mirrors 13b and 13c, and allows light from the plurality of light sources 11a˜11c to propagate along a single light path through the combination of the light.

The illumination unit 14 converts light having passed through the condensing unit 12 into linear parallel light, and allows the linear parallel light to enter the diffractive optical modulator 18. The diffractive optical modulator 18 generates linear diffracted light having a plurality of diffraction orders by modulating incident linear parallel light and emits the linear diffracted light. Here, diffracted light having a desired one of the diffraction orders may be configured such that the light intensity thereof varies depending on the location so as to form an image on the screen 28. That is, since the diffracted light generated by the diffractive optical modulator 18 is linear and the intensity of the linear diffracted light may vary depending on the location, it can produce a two-dimensional image on the screen 28 when it is scanned across the screen 28.

The diffracted light produced by the diffractive optical modulator 18 enters the Fourier filter unit 20. The Fourier filter unit 20 includes a Fourier lens 21 and a dichroic filter 22, separates the diffracted light according to diffraction order, and passes only diffracted light having a desired diffraction order therethrough.

The projection unit 24 includes a projection lens 25 and a scanner 26. The projection lens 25 expands incident diffracted light, and the scanner 26 produces an image by projecting incident diffracted light onto the screen 28.

Meanwhile, according to the prior art, diffracted light is directly projected onto the screen 28 by the projection unit 24, so that the projection distance from the scanner 26 to the screen 28 at a center point A in the lateral direction, that is, the scanning direction, of the screen 28 is different from that at edge points A′ on the right and left sides of the screen 28, and thus a distorted image is produced on the screen 28, as shown in FIG. 2A. That is, when, in FIG. 1, the projection distance from the scanner 26 to the screen 28 at the center point A in the lateral direction of the screen 28 is compared with the projection distance from the scanner 26 to the screen 28 at the edge points A′ on the right and left sides of the screen 28, the latter projection distance is longer than the former projection distance by a distance “a”, thereby causing distortion, as shown in FIG. 2A. When, for ease of understanding of this, the screen 28 is viewed from the front and a virtual plane 28′ having the same projection distance is considered, as shown in FIG. 2B, a longer distance is required for an image to be formed at right and left edge points A′ of the screen 28, rather than at the center point A of the scanner 26. Accordingly, light propagates along a longer distance, so that an image is vertically expanded, with the result that distortion occurs, as shown in FIG. 2B.

### SUMMARY OF THE INVENTION

Accordingly, the present invention has been made keeping in mind the above problems occurring in the prior art, and the present invention is intended to provide a display device using a diffractive optical modulator and having an image distortion function, which is capable of reducing image distortion when generating diffracted light by modulating incident light using the diffractive optical modulator and producing a two-dimensional image by projecting the generated diffracted light onto a screen.

In order to accomplish the above object, the present invention provides a display device using a diffractive optical modulator and having a distortion correction function, including a light source unit including a plurality of light sources for emitting beams of light having different wavelengths; a condensing unit for causing the beams of light, emitted from the plurality of the light sources of the light source unit, to have an identical light path; an illumination unit for converting the beams of light, emitted from the light sources of the light source unit, into linear light; a diffractive optical modulator for modulating the linear light when the linear light is incident from the illumination unit, so that diffracted light having a plurality of diffraction orders, in which diffracted light having at least one desired diffraction order has appropriate light intensities at respective locations thereof, is generated; a projection unit for producing an image by projecting the diffracted light, emitted from the diffractive optical modulator, onto a screen; a filter unit for passing only diffracted light having at least one desired diffraction order, selected from the diffracted light having a plurality of diffraction orders generated by the diffractive optical modulator, therethrough; and a distortion correction means including a lens array for correcting an image that will be formed by the diffracted light projected onto the screen by the projection unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a prior art display device using a diffractive light modulator;

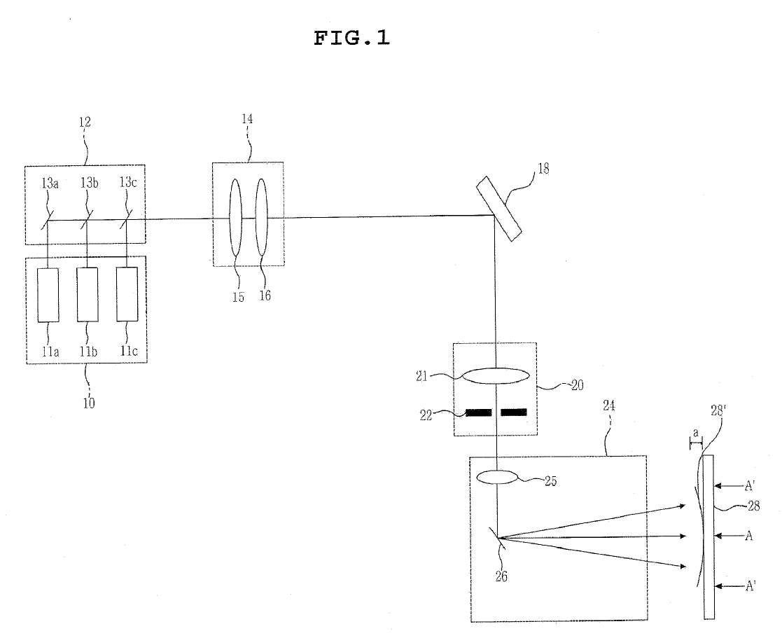

FIG. 2A is a diagram showing image distortion occurring on the screen of FIG. 1, and FIG. 2B is a diagram showing a virtual plane having the same projection distance when the screen of FIG. 1 is viewed from the front;

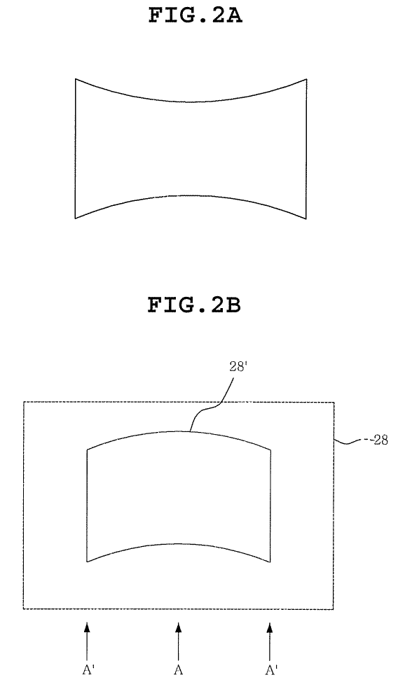

FIG. 3 is a diagram showing the construction of a display device using a diffractive modulator and having a distortion correction function according to an embodiment of the present invention;

FIG. 4 is a diagram showing the construction of a display device using a diffractive modulator and having a distortion correction function according to another embodiment of the present invention;

FIG. 5 is a plan view showing another embodiment of the distortion correction lens array shown in FIGS. 3 and 4; and

FIG. 6A is a plan view showing a unit lens of the distortion correction lens array of FIGS. 3 to 5, FIG. 6B is a front view showing a unit lens of the distortion correction lens array of FIGS. 3 to 5, and FIG. 6C is a side view showing a unit lens of the distortion correction lens array of FIGS. 3 to 5.

### DESCRIPTION OF THE PREFERRED EMBODIMENTS

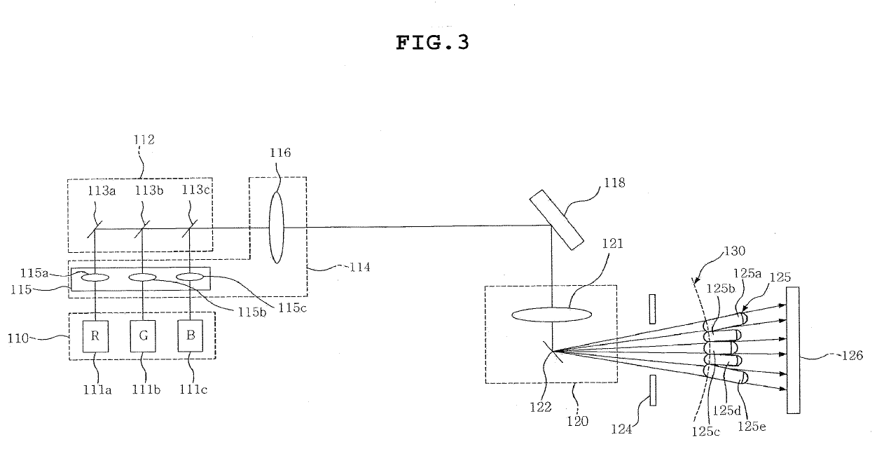

With reference to FIGS. 3 to 6C, a display device using a diffractive optical modulator and having a distortion correction function according to the present invention is described in detail below.

FIG. 3 is a diagram showing the construction of a display device using a diffractive optical modulator and having a distortion correction function according to an embodiment of the present invention.

Referring to FIG. 3, the construction of the display device using a diffractive optical modulator and having a distortion correction function according to the present embodiment of the present invention includes a light source unit 110 for generating and emitting a plurality of beams of light, a condensing unit 112 for unifying the light paths of the plurality of beams of light emitted from the light source unit 110, an illumination unit 114 for converting light, emitted from the condensing unit 112, into linear parallel light and allowing the linear parallel light to enter a diffractive optical modulator 118, a diffractive optical modulator 118 for generating and emitting diffracted light having a plurality of diffraction orders by diffracting light incident from the illumination unit 114 so that diffracted light associated with at least one diffraction order can produce a desired image, a projection unit 120 for projecting diffracted light having a plurality of diffraction orders, generated by the diffractive optical modulator 118, onto a screen 126, a filter unit 124 disposed between the projection unit 120 and the screen 126 and configured to pass diffracted light having at least one desired diffraction order therethrough, and a distortion correction means 125 formed of a lens array and configured to correct image distortion when diffracted light is projected from the projection unit 120 onto the screen 126.

The light source unit 110 includes a plurality of light sources, specifically, a red light source 111a, a green light source 111b, and a blue light source 111c. Laser diodes or light emitting diodes may be used as respective light sources 111a, 111b and 111c. If the light source unit 110 emits Red (R) light, Green (G) light and Blue (B) light in a time division fashion in the case where only a single diffractive optical modulator 118 is employed, as in the present embodiment of the present invention, it is not necessary to provide a separate color wheel (a device capable of dividing a multbeam according to color; not shown) upstream or downstream of the diffractive optical modulator 118. Of course, if the light source unit 110 emits a plurality of beams of light at the same time, that is, the light source unit 110 emits a plurality of beams of light without time division, a separate color wheel is provided in front of or behind the diffractive optical modulator 118, so that a plurality of beams of light does not enter the diffractive optical modulator 118 at the same time, but enters the diffractive optical modulator 118 at different times.

The condensing unit 112, in an embodiment, includes one reflective mirror 113a and two dichroic mirrors 113b and 113c, and allows light emitted from the plurality of light sources 111a, 111b and 111c to have the same light path. That is, the reflective mirror 113a directs R light along a desired light path by changing the path of light emitted from the R light source 111a, the next dichroic mirror 113b passes R light therethrough, and directs R light and G light along the same light path by reflecting G light emitted from the G light source 111b, and the next dichroic mirror 113c passes R light and G light therethrough, and directs R light, G light and B light along the same light path by reflecting B light emitted from the G light source 111c.

Meanwhile, the collimating lens unit 115 of the illumination unit 114 is located between the light source unit 110 and the condensing unit 112. Here, the collimating lens unit 115 includes a plurality of collimating lenses 115a, 115b and 115c. Respective collimating lenses 115a, 115b and 115c are located such that they correspond to respective light sources 111a, 111b and 111c of the light source unit 110, and convert diverging light from the light sources 111a, 111b and 111c into parallel light.

The cylinder lens 116 of the illumination unit 114 is located behind the condensing unit 112, and converts parallel light, emitted from the condensing unit 112, into linear light and causes the linear light to enter the diffractive optical modulator 118.

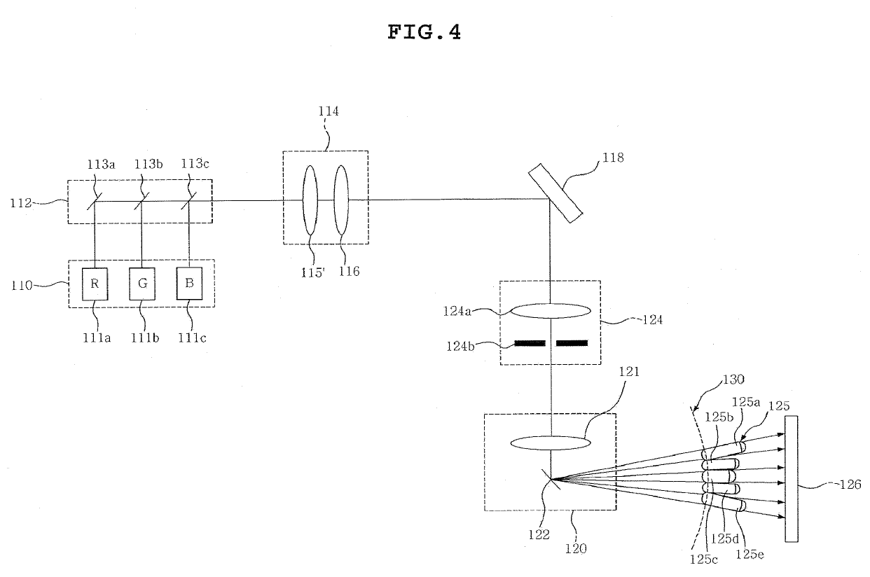

Although the present embodiment of the present invention is configured such that the collimating lens unit 115 of the illumination unit 114 is located between the light source unit 110 and the condensing unit 112 and the cylinder lens 116 is located downstream of the condensing unit 112, the collimating lens 115′ of the illumination unit 114 may be located downstream of the condensing unit 112 in another embodiment, as shown in FIG. 4. By doing so, the latter embodiment can produce desired parallel light using only a single collimating lens 115′, unlike the present embodiment, in which the collimating lens unit 115 composed of three collimating lenses 115a, 115b and 115c is used, as shown in FIG. 3, thereby achieving a reduction in cost.

When linear parallel light is incident from the illumination unit 114, the diffractive optical modulator 118 produces diffracted light having a plurality of diffraction orders through optical modulation and emits the diffracted light. Here, diffracted light having a plurality of diffraction orders, emitted from the diffractive optical modulator 118, is linear light from a diffraction order viewpoint.

Furthermore, diffracted light having a desired diffraction order, which is selected from the diffracted light having a plurality of diffraction orders emitted from the diffractive optical modulator 118 and is intended to be projected onto the screen 126 to form an image, can be configured to have light intensity varying depending on the location thereof, so that a desired image can be produced by projecting diffracted light having the corresponding diffraction order onto the screen 126. Furthermore, respective beams of diffracted light having a plurality of diffraction orders, which is emitted from the diffractive optical modulator 118, propagate at different diffraction angles.

The projection unit 120 includes a projection lens 121 and a scanner 122, and expands the linear diffracted light emitted from the diffractive optical modulator 118 and scans the expanded light onto the screen 126, thereby producing a two-dimensional image.

The projection lens 120 of the projection unit 120 expands the diffracted light having a plurality of diffraction orders, which is emitted from the diffractive optical modulator 118.

The scanner 122 of the projection unit 120 produces a two-dimensional image by scanning the linear diffracted light having a plurality of diffraction orders, which is expanded by the projection lens 121, onto the screen 126.

Here, a Galvano meter mirror or a polygon mirror may be used as the scanner 122.

A slot or a dichroic filter may be used as the filter unit 124. The filter unit 124 passes diffracted light having a desired diffraction order therethrough and blocks diffracted light having undesired diffraction orders, among the diffracted light having a plurality of diffraction orders, which is emitted from the projection unit 120. The filter unit 124 does not need to include a separate Fourier lens.

That is, as described above, respective beams of the diffracted light having a plurality of diffraction orders, which are emitted from the diffractive optical modulator 118, propagate at different diffraction angles. If the filter unit 124 is disposed at a location sufficiently remote from the diffractive optical modulator 118, the diffracted light having a plurality of diffraction orders enters the filter unit 124 while ensuring therebetween a nearest distance sufficient to separate the beams of diffracted light having a plurality of diffraction orders using a slot or dichroic filter, so that a separate Fourier lens is not required.

Meanwhile, the filter unit 124 is not located downstream of the projection unit 120, as shown in the embodiment of FIG. 3, but may be located downstream of the diffractive optical modulator 118, as shown in another embodiment of FIG. 4. In this case, the filter unit 124 includes a Fourier lens 124a and a Fourier filter 124b. The Fourier lens 124a separates the diffracted light having a plurality of diffraction orders so that the nearest distance is sufficiently ensured between the beams of diffracted light having a plurality of diffraction orders, and the Fourier filter 124b passes diffracted light having a desired diffraction order therethrough.

The distortion correction means 125 is formed of a lens array, and compensates for image distortion, so that an image formed on the screen 126 has the same distance at the center and right and left edges thereof, thereby preventing image distortion.

An embodiment of the distortion correction means 125 is shown in FIGS. 3 and 4. In this embodiment, spherical lenses 125a˜125e each having a spherical light entry surface and a spherical light exit surface constitute the lens array of the distortion correction means 125.

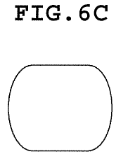

Respective lenses 125a˜125e are spherical lenses that each have a spherical light entry surface and a spherical light exit surface from the viewpoint of the plan view of FIG. 6A. Furthermore, the respective lenses 125a˜125e are rectangular lenses from the viewpoint of the front view of FIG. 6B. The vertical side of each of the lenses 125a˜125e is longer than the lateral side thereof so that linear diffracted light can enter them and then be scanned.

Moreover, the respective lenses 125a˜125e are spherical lenses that each have a long side across which light propagates, as seen from the side view of FIG. 6C.

Referring to FIGS. 3 and 4, in the arrangement of the lenses 125a˜125e of the image distortion correction means 125, the light entry surfaces thereof may be located along a circular surface 130 around the scanner 122.

Furthermore, in the arrangement of the lenses 125a˜125e of the distortion correction means 125, lenses must be arranged such that the focal distance thereof increases in proportion to the distance from the center. Accordingly, when the focal distances of the lenses 125a˜125e increase in proportion to the distances to the center, the divergence of incident light is decreased, thereby mitigating image distortion.

That is, when the focal distance of the lenses 125b and 125d, which are located on the right and left sides of the lens 125c, is increased, the divergence of diffracted light incident on the lenses 125b and 125d is decreased. Accordingly, even when center diffracted light propagates a longer distance than side diffracted light, the diffracted light having passed through the side lenses 125b and 125d has almost the same width as the diffracted light having passed through the center lens 125c.

The same description can be applied to reference numeral 125b and its neighboring reference numeral 125a, and also to reference numeral 125d and its neighboring numeral 125e.

Although the differentiation of the focal distances of the lenses 125a˜125e can be achieved by varying the thicknesses of the lenses, as shown in FIGS. 3 and 4, the focal distances of the lenses can become different using different radii of curvature even though the thicknesses of the lenses are the same.

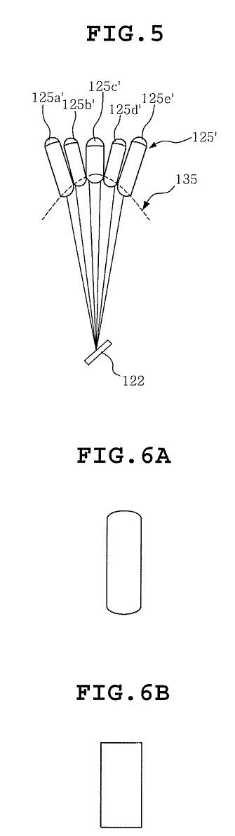

Meanwhile, the lenses 125a′˜125e′ of the image distortion correction means 125 may be arranged along a parabolic surface using the scanner 122 as a focal point, as described in FIG. 5, in which case each of the lenses 125a′˜125e may have a fan shape.

According to the above-described present invention, an advantage is achieved in that image distortion occurring at the center and right and left edges of a screen can be reduced when linear diffracted light, generated by the diffractive optical modulator, is projected onto the screen using a scanner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A display device using a diffractive optical modulator and having a distortion correction function, comprising:
a light source unit comprising a plurality of light sources for emitting beams of light having different wavelengths;
a condensing unit for causing the beams of light, emitted from the plurality of the light sources of the light source unit, to have an identical light path;
an illumination unit for converting the beams of light, emitted from the light sources of the light source unit, into linear light;
a diffractive optical modulator for modulating the linear light when the linear light is incident from the illumination unit, so that diffracted light having a plurality of diffraction orders, in which diffracted light having at least one desired diffraction order has appropriate light intensities at respective locations thereof, is generated;
a projection unit for producing an image by projecting the diffracted light, emitted from the diffractive optical modulator, onto a screen;
a filter unit for passing only diffracted light having at least one desired diffraction order, selected from the diffracted light having a plurality of diffraction orders generated by the diffractive optical modulator, therethrough; and
distortion correction means comprising a lens array for correcting an image that will be formed by the diffracted light projected onto the screen by the projection unit.

2. The display device as set forth in claim 1, wherein the projection unit comprises:
a projection lens for expanding the diffracted light having a plurality of diffraction orders, emitted from the diffractive optical modulator; and
a scanner for scanning the diffracted light, incident from the projection lens, onto the screen.

3. The display device as set forth in claim 1, wherein the filter unit is disposed between the projection unit and the screen, and passes only the diffracted light having at least one desired diffraction order, selected from the diffracted light having a plurality of diffraction orders projected from the projection unit, therethrough.

4. The display device as set forth in claim 1, wherein the filter unit is disposed downstream of the diffractive optical modulator, and passes only the diffracted light having at least one desired diffraction order, selected from the diffracted light having a plurality of diffraction orders emitted from the diffractive optical modulator, therethrough.

5. The display device as set forth in claim 1, wherein the distortion correction means comprises an array of lenses having different focal distances.

6. The display device as set forth in claim 5, wherein the distortion correction means is configured such that the lenses have light entry surfaces that are sequentially arranged along a circular surface.

7. The display device as set forth in claim 5, wherein the distortion correction means is configured such that the lenses have light entry surfaces that are sequentially arranged along a parabolic surface.

8. The display device as set forth in claim 5, wherein the distortion correction means is configured such that the lenses have focal distances that are determined depending on different thicknesses of the lenses.

9. The display device as set forth in claim 5, wherein the distortion correction means is configured such that the lenses have focal distances that are determined depending on different radii of curvature of the lenses.
